(19) United States
(12) Patent Application Publication
(10) Pub. No.: US 2009/0147851 A1
(43) Pub. Date: Jun. 11, 2009

(54) MOTION VECTOR FIELD PROJECTION DEALING WITH COVERING AND UNCOVERING

(75) Inventors: Reinier Bernardus Maria Klein Gunnewiek, Eindhoven (NL); Rimmert Wittebrood, Eindhoven (NL); Ralph Braspenning, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,782

(22) PCT Filed: Nov. 17, 2005
(86) PCT No.: PCT/IB2005/053797

§ 371 Date: May 21, 2007

(30) Foreign Application Priority Data
Nov. 22, 2004 (EP) 04105951.0

(51) Int. Cl. H04N 7/26

(52) U.S. Cl. 375/240.16; 375/E07.123

(57) ABSTRACT

The method for high efficiency video signal compression comprises: a) calculating a first motion vector field (MvI) at a temporal location (t3) of a third video picture (125) by using pixel data of a second video picture (123) and the third video picture; b) calculating a second motion vector field (Mv2) at a temporal location (t2) of the second video picture (123), in which second motion vector field (Mv2) a foreground motion region (rFG2) composed of positions of foreground motion vectors, having a magnitude substantially equal to the motion of a foreground object (101), substantially collocates spatially with positions of pixels of the foreground object (101) and not with pixels of a background object (103, 103′); c) correcting erroneous foreground motion vectors (rERR) in an uncovering region of the first motion vector field (MvI) on the basis of the second motion vector field (Mv2); d) determining in a region (COV) of the first motion vector field corresponding to covering of background object pixels by the foreground object which of two vectors, projecting to a same spatial position in a future picture, is a foreground motion vector (vFG) and which is a background motion vector (vBG); e) projecting motion vectors of the first motion vector field to a temporal location (t4) of a fourth video picture (127) to be predicted, obtaining a third motion vector field (Mv3), comprising allocating a foreground motion vector (vFG) in the case of two vectors projecting to the same spatial position in the third motion vector field (Mv3); and f) predicting the fourth video picture (127) by using the third motion vector field (Mv3) for determining positions of pixels to be fetched from at least one previous image (125).

The invention relates to a method and apparatus of video compression, a method and apparatus of video decompression, software implementing the methods, and a digital television unit, video signal recorder and portable video apparatus comprising the video compression and/or decompression apparatus.

The quest in video compression is to have an ever smaller amount of bits to faithfully (i.e. with as little visible artifacts as possible) represent a sequence of pictures. Current video compression standards like MPEG-2 and AVC (advanced video coding) use motion prediction to encode a group of pictures (GOP). A group of pictures starts with a so-called intra-coded (I) picture which is encoded solely on the basis of its own content, followed by predicted (P,B) pictures, which are regenerated on the basis of a motion-prediction of where the objects of the I picture would reside in the P or B pictures, and a correction picture (a so-called residue). The motion-prediction is typically done by calculating/transmitting a motion vector field for the temporal instant of the picture to be predicted, and by fetching the pixels of the objects from the past. In this way each pixel of the picture to be predicted is guaranteed to have a value allocated. Projecting pixels of a previous picture to a picture to be predicted could also be envisaged, but this is less preferred, since it introduces problems of doubly and unallocated regions of pixels in the picture to be predicted.

In a compressed video stream there is a certain amount of the required bits for encoding the pixel data (i.e. intra-coded pictures and pixel residues) and an amount for encoding the motion vector fields required for prediction. In the past numerous strategies were developed for reducing the amount of bits required for the pixels (e.g. adaptation of the quantization), however then the percentage of bits required for the motion vectors is a large amount of the total—especially for lower bit-rate applications—hence some compression could be achieved for the motion vectors too.

It is a disadvantage of the prior art compression methods (e.g. MPEG-2) that they only use very simple prediction of the motion vectors: within a motion vector field, the motion vector for a block is coded differentially compared to his left neighbor (i.e. if the left vector has a magnitude of 16 pixels/frame and the right vector 18 pixels/frame, than this right vector has a compressed differential value of 2, requiring less bits than its actual value). This so-called “differential pulse code modulation” is an old and not very efficient strategy.

It is an object of the invention to provide a method of video (de)compression which is relatively efficient, more particularly has a strategy allowing a reduced number of bits for encoding motion vectors.

This object is realized in that the method comprises:

a) calculating a first motion vector field (Mv1) at a temporal location of a third video picture by using pixel data of a second video picture and the third video picture;
b) calculating a second motion vector field (Mv2) at a temporal location of the second video picture, in which second motion vector field a foreground motion region (rFG2) composed of positions of foreground motion vectors, having a magnitude substantially equal to the motion of a foreground object, substantially collocates spatially with positions of pixels of the foreground object (101) and not with pixels of a background object;
c) correcting erroneous foreground motion vectors (rERR) in the first motion vector field on the basis of the second motion vector field;
d) determining in a region of the first motion vector field corresponding to covering of background object pixels by the foreground object which of two vectors, projecting to a same spatial position in a future picture, is a foreground motion vector and which is a background motion vector;
e) projecting motion vectors of the first motion vector field to a temporal location of a fourth video picture to be predicted, obtaining a third motion vector field, comprising allocating a foreground motion vector in the case of two vectors projecting to the same spatial position in the third motion vector field; and
f) predicting the fourth video picture by using the third motion vector field for determining positions of pixels to be fetched from at least one previous image.

The first five steps form a motion vector field prediction part of the picture prediction. If one wants to reduce the number of bits allocated to the motion vectors coding, one can use an algorithm which allows the receiver/decompressor to predict motion vectors, because for all the information that can be predicted, no or little data has to be compressed/transmitted. However, then a prediction of the motion vectors should be accurate, otherwise the predictions of the pixels of a picture to be predicted will be wrong, resulting in either severe artifacts, or an large amount of correction data. It is proposed in this application to extrapolate motion vector fields. Vector fields for pictures already decompressed can be calculated at the receiver/decompressor side with motion estimation (although if not done as below with considerable errors). A vector field required for the (fetching from the past) prediction of a picture cannot simply be calculated, at least not with a classical 2-picture motion estimator, since that would require the presence at the decompressor of the picture to be predicted itself. However a motion vector field can be extrapolated: it is likely that the motion vectors of objects move to the future together with the objects themselves. The compressor can with a “mirror-algorithm” predict what the decompressor will be able to predict (motion vector fields and resulting predicted pictures) and where required according to the quality specifications of the compression calculate and transmit a correction residue. Either the predicted motion vector fields can be fine-tuned with a transmitted corrective motion vector field (containing typically small correction motion vectors requiring few bits, in the present method mostly for isolated occlusion [covering/uncovering] regions), or no correction for the motion vectors is transmitted, the resulting picture prediction errors being corrected entirely with a higher bit amount residue picture.

Using a classical motion estimation (e.g. full search or optic flow) on the two lastly decompressed video pictures to obtain the first motion vector field, poses a problem, since the obtained vector field is too erroneous for good quality vector field extrapolation. In particular in regions of uncovering, the motion vectors are incorrectly estimated. However by using information from previous pictures, one can correct the erroneous first vector field. E.g. a three-picture motion estimator on the three lastly decompressed pictures can be devised which has vectors precisely matching to all foreground objects (in particular when using e.g. a “3DRS” motion estimator, the magnitudes of the vectors are also everywhere very near the true motion of the object [accurate], i.e. it yields no spurious vectors but a well-matching, consistent, accurate vector field). In particular it will not show foreground motion vectors allocated to background pixels. Of course this is true substantially up to second order effects within the accuracy of the motion estimation. If e.g. motion vectors are calculated for 16×16 pixel blocks, it is typical that a vector field will overflow to a few background pixels in a block which is mostly collocating with a foreground object.

Having such a precisely matching second motion vector field means that the first motion vector field can be corrected so that it also becomes well-matching. E.g. borders between foreground and background motion can be determined in the second motion vector field and their locations can be projected to the first motion vector field, giving correctly positioned borders in this vector field.

Having a precisely matching first motion vector field allows two strategies (of which it is emphasized that they differ only in further modifications hence have unity of invention) for finally predicting a new picture of a sequence of pictures. Either a third vector field for pixel fetching can be determined by extrapolating the corrected first motion vector field, or as described below, the pixels can be extrapolated to the future themselves, in which case a third vector field is not required.

In any case, further steps are required for performing an extrapolation. Namely, firstly there will be covering regions which lead to double allocation, for which a correct (foreground) vector or pixel to project has to be identified. Secondly there will be unallocated regions in the picture/vector field to be predicted, for which a kind of additional prediction—e.g. interpolation—is required, or e.g. corrected with the picture residue only.

In an embodiment of the method the calculating of the second motion vector field is done on the basis of the third video picture, the second video picture and a first video picture, e.g. with a three-picture motion estimator.

In another embodiment or a further modification of the previous embodiment, the correcting of the erroneous foreground motion vectors in the first motion vector comprises:

detecting an uncovering region in the second motion vector field (Mv2);

deriving on the basis of this uncovering region a region (rERR) of erroneous motion vectors in the first motion vector field (Mv1); and

allocating background motion vectors to the pixels of the region (rERR) of erroneous motion vectors.

A simple way is to just determine where the uncovering regions are and allocate background motion vectors instead of the calculated foreground motion vectors, since for most video sequences these will be the correct vectors.

The background vector allocated is e.g. a background vector from outside the region of no projecting. Since uncovering regions are typically not too large compared to the complexity of the motion of the background (e.g. simple translation or weak perspective) background motion vectors which were correctly estimated just outside the uncovering region will in general be good predictions for the motion vectors inside this problem region. Note that whereas for the third motion vector field Mv3 it does not matter whether the uncovering regions contain the correct background motion vectors (for fetching prediction) or indeed any motion vectors at all, it is desirable that the first motion vector field Mv1 has approximately the correct background motion vectors (or at least that the border between the foreground motion vectors and background motion vectors is relatively precisely located), since this first motion vector field will be used for temporal extrapolation, hence e.g. the size of the uncovering region in the third motion vector field will be determined by it. However e.g. a slightly too large or too small unallocated region of Mv3 can still be post-corrected with a residue vector field. Similarly erroneous pixel projection by slightly inaccurate background motion vectors in the alternative method can also be corrected with the pixel residue picture.

In another embodiment, the foreground motion vector which is allocated, in the case of two vectors projecting to the same spatial position in the third motion vector field, is the foreground one of the two projecting vectors.

There are different ways to do the identification of foreground and background vectors, for the interpolation, but also for resolving the double allocation. E.g., in the case where there is uniform translational motion of foreground and background, a global foreground and background motion vector may be determined (this may be generalized to global models e.g. for zoom, perspective transformation etc. on background and/or foreground). The foreground motion vector which is then used in case of double allocation may be the global foreground motion vector. It may be better however to use the locally measured actual motion vector (which projects to the point of double allocation). Whether such a local vector is a foreground or background vector may be determined with various strategies such as e.g. looking at its SAD (good block match for foreground vectors vs. bad match for background vectors; of course only looking to the past where reconstructed pictures are available) or calculating a difference with the global foreground motion vector.

In unallocated uncovering regions of the third motion vector field one can either allocate no motion vector (the prediction than being corrected with a residue picture) or a useful motion vector which gives a reasonable first prediction to what the actual pixel values of the picture to be predicted at that temporal instant are (a better prediction than what is achieved with a background motion vector, fetching from the foreground object in a previous picture).

Possibilities are to for allocation of useful vectors in the uncovering regions of Mv3 are e.g.:

a vector obtained form a full search (e.g. around a foreground motion vector value) minimizing a prediction error (e.g. a block SAD), which can be one vector for the whole uncovering region in Mv3 or a number of vectors for different sub-regions of the uncovering region.

A foreground motion vector, which fetches from the background in an incorrect position, but still yielding a good prediction for the pixels (e.g. correct average value, leads to lower residue).

A null vector

A “no fetch” code may also be allocated, in which case another algorithm may give a first prediction, such as a pixel extrapolation.

A variant compression method employing the same idea of getting a well-matching corrected first vector field for further prediction comprises:

a) calculating a first motion vector field (Mv1) at a temporal location (t3) of a third video picture (125) by using pixel data of a second video picture (123) and the third video picture;
b) calculating a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) correcting erroneous foreground motion vectors in the first motion vector field (Mv1) on the basis of the second motion vector field (Mv2);
d) determining in a region (COV) of the first motion vector field corresponding to covering of background object pixels by the foreground object which of two vectors, projecting to a same spatial position in a future picture, is a foreground motion vector (vFG) and which is a background motion vector (vBG);
e) projecting with the motion vectors of the corrected first motion vector field (Mv1) pixels of the third video picture (125) to a fourth video picture (127) initialized to zero, comprising in the case of double projection, projecting only pixels having a foreground motion vector (vFG).

The above compression methods and embodiments contain mirrors of what happens in the receiving side during decompression (the difference lying in the final reconstruction i.e. a residual addition), hence a number of further methods and apparatuses are disclosed in accordance with the object of the invention.

A method of video signal decompression comprising:

a) calculating a first motion vector field at a temporal location of a previously decompressed third video picture by using pixel data of a previously decompressed second video picture and the third video picture;
b) calculating a second motion vector field at a temporal location of the second video picture, in which second motion vector field a foreground motion region composed of positions of foreground motion vectors, substantially equal to the motion of a foreground object, substantially collocates spatially with positions of pixels of the foreground object and not with pixels of a background object;
c) correcting erroneous foreground motion vectors in the first motion vector field on the basis of the second motion vector field;
d) determining in a region of the first motion vector field corresponding to covering of background object pixels by the foreground object which of two vectors, projecting to a same spatial position in a future picture, is a foreground motion vector and which is a background motion vector;
e) projecting motion vectors of the first motion vector field to a temporal location of a fourth video picture to be predicted, obtaining a third motion vector field, comprising allocating a foreground motion vector in the case of two vectors projecting to the same spatial position in the third motion vector field; and
f) predicting the fourth video picture by using the third motion vector field for determining positions of pixels to be fetched from at least one previous image.

A method of video signal decompression comprising:

a) calculating a first motion vector field at a temporal location of a previously decompressed third video picture by using pixel data of a previously decompressed second video picture and the third video picture;
b) calculating a second motion vector field at a temporal location of the second video picture, in which second motion vector field a foreground motion region composed of positions of foreground motion vectors, substantially equal to the motion of a foreground object, substantially collocates spatially with positions of pixels of the foreground object and not with pixels of a background object;
c) correcting erroneous foreground motion vectors in the first motion vector field on the basis of the second motion vector field;
d) determining in a region of the first motion vector field corresponding to covering of background object pixels by the foreground object which of two vectors, projecting to a same spatial position in a future picture, is a foreground motion vector and which is a background motion vector;
e) projecting with the motion vectors of the corrected first motion vector field pixels of the third video picture to a fourth video picture initialized to zero, comprising in the case of double projection projecting only pixels having a foreground motion vector.

A video (de)compression apparatus comprising:

a) a a first motion estimation unit (605) arranged to calculate a first motion vector field (Mv1) at a temporal location (t3) of a third video picture (125) by using pixel data of a second video picture (123) and the third video picture;
b) a second motion estimation unit (607) arranged to calculate a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) a correction unit (609) arranged to correct erroneous foreground motion vectors in the first motion vector field (Mv1) on the basis of the second motion vector field (Mv2);
d) a foreground/background detector (621) arranged to determine in a region (COV) of the first motion vector field corresponding to covering of background object pixels by the foreground object which of two vectors, projecting to a same spatial position in a future picture, is a foreground motion vector (vFG) and which is a background motion vector (vBG);
e) a projection unit (619) arranged to project motion vectors of the first motion vector field to a temporal location (t4) of a fourth video picture (127) to be predicted, yielding as output a third motion vector field (Mv3), comprising allocating a foreground motion vector (vFG) in the case of two vectors projecting to the same spatial position in the third motion vector field (Mv3);
f) an interpolation unit (617) arranged to allocate a good-predicting motion vector in spatial positions (UNCOV) of the third motion vector field (Mv3) where no projecting of a vector from the first vector field occurred; and
g) a picture prediction unit (625) arranged to predict the fourth video picture (127) by using the third motion vector field (Mv3) for determining positions of pixels to be fetched from at least one previous image.

A video (de)compression apparatus comprising:

a) a first motion estimation unit (605) arranged to calculate a first motion vector field (Mv1) at a temporal location (t3) of a third video picture (125) by using pixel data of a second video picture (123) and the third video picture;
b) a second motion estimation unit (607) arranged to calculate a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) a correction unit (609) arranged to correct erroneous foreground motion vectors in the first motion vector field (Mv1) on the basis of the second motion vector field (Mv2);
d) a foreground/background detector (621) arranged to determine in a region (COV) of the first motion vector field corresponding to covering of background object pixels by the foreground object which of two vectors, projecting to a same spatial position in a future picture, is a foreground motion vector (vFG) and which is a background motion vector (vBG);
e) a picture prediction unit (625) arranged to project with the motion vectors of the corrected first motion vector field (Mv1) pixels of the third video picture (125) to a fourth video picture (127) initialized to zero, and arranged to in the case of double projection project only pixels having a foreground motion vector.

A compressed video signal produced by one of the above described methods or embodiments, comprising only residue motion vectors for temporal positions of motion predicted pictures, which residue is in view of its spatial structure clearly identifiable as only usable for correcting temporally predicted motion vector fields.

The signal will contain much less motion vector data as a classical (e.g. MPEG-2) signal, and the residues may typically show a correlation with occlusion regions.

The compression or decompression apparatus may typically be incorporated in various realizations of a digital television unit, e.g. a stand-alone television receiver with display, a set-top-box, a wireless video apparatus such as e.g. a wireless LCD TV, etc.

The compression or decompression apparatus may also be incorporated in a video signal recorder such as e.g. a reading/writing disk recorder (optical disk, hard-disk, . . . ), or a p.c. home video database server.

The compression or decompression apparatus may also be incorporated in a portable video apparatus, such as a portable p.c., a portable assistant or entertainment apparatus, a mobile phone, etc., which may e.g. comprise a camera, the captured pictures of which may be compressed according to the present invention.

The apparatuses and methods may be used both in a consumer-home, and in professional environments, such as e.g. television studios, transcoding by providers to lower capacity networks, etc.

These and other aspects of the compression and decompression methods and apparatuses according to the invention will be apparent from and elucidated with reference to the implementations and embodiments described hereinafter, and with reference to the accompanying drawings, which serve merely as non-limiting specific illustrations exemplifying the more general concept, and in which dashes are used to indicate that a component is optional.

In the drawings:

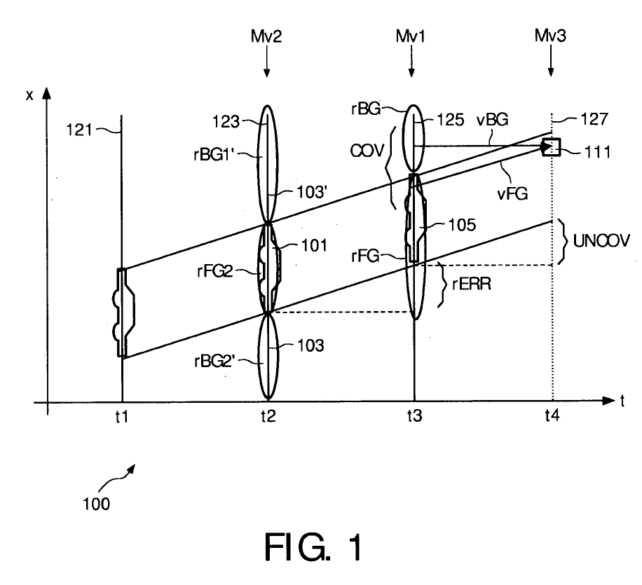

FIG. 1 schematically shows the correction of a first motion vector field usable for the prediction of a fourth picture according to the invention;

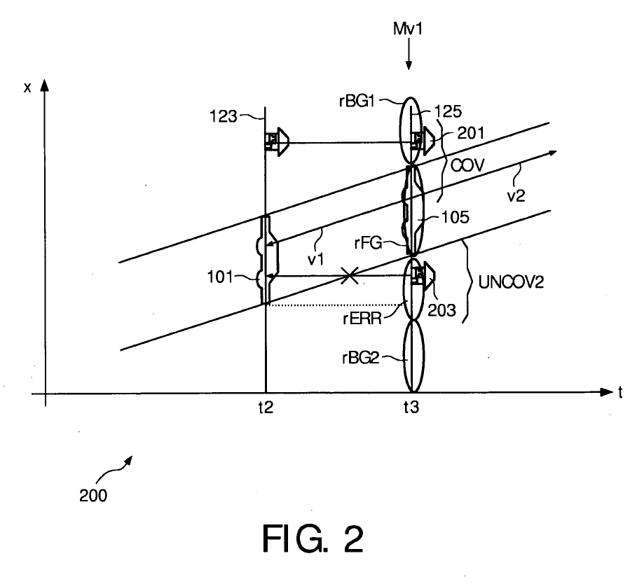

FIG. 2 schematically shows the step of the two-picture motion estimation of the first motion vector field;

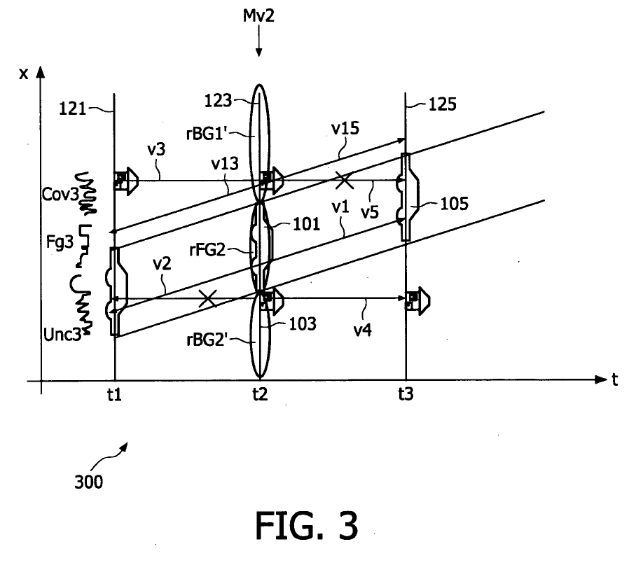

FIG. 3 schematically shows the step of the three-picture motion estimation to obtain a second motion vector field;

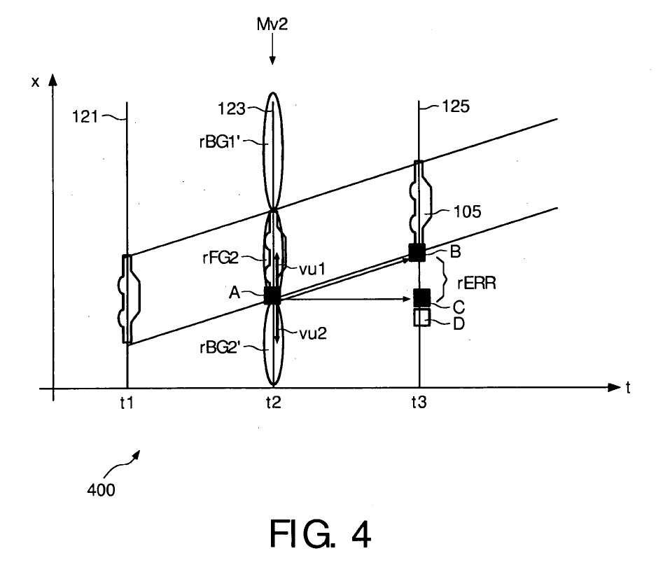

FIG. 4 symbolically shows a correction of the first motion vector field according to the invention;

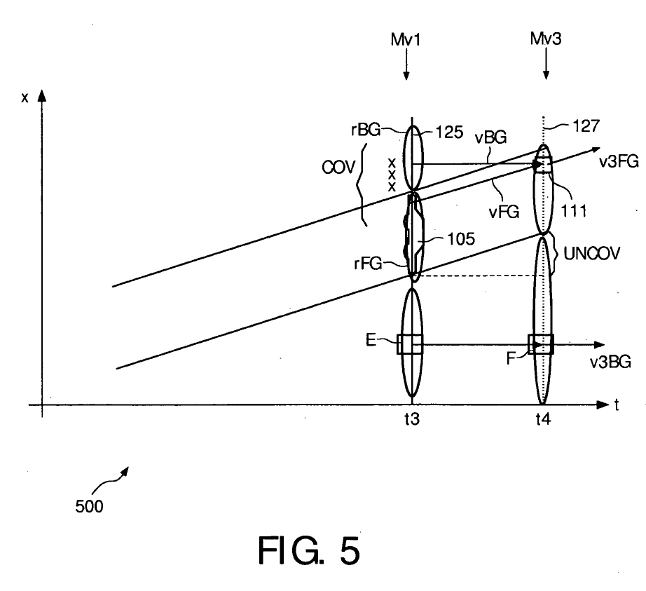

FIG. 5 schematically shows a projection of the corrected first motion vector field to obtain a third motion vector field according to the invention; and

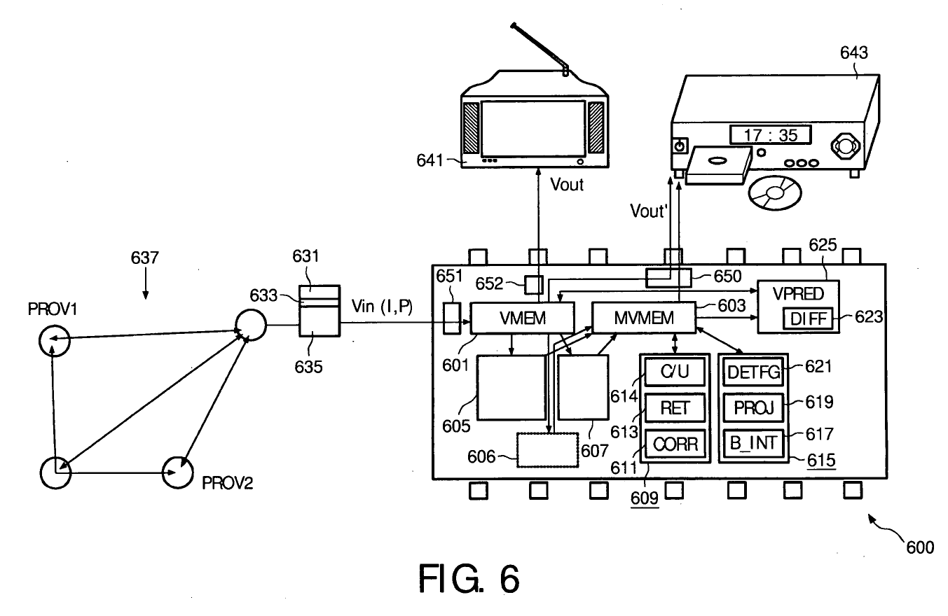

FIG. 6 schematically shows a video compression/decompression apparatus according to the invention.

FIG. 1 schematically shows in a temporal graph 100 of consecutive video pictures, a first motion vector field Mv1 estimated/calculated by looking e.g. for each region (e.g. an 8×8 block) of pixels present in a third video picture 125 for a corresponding region of pixels (i.e. approximately the same geometrical distribution of pixel grey values) in the previous video picture, namely a second video picture 123. It should be noted that other prior art motion estimation techniques may be employed, e.g. optical flow-based methods, as long as a motion vector field is obtained. Preferably a so-called “3DRS” block based motion estimation is used (see e.g. WO01/88852), since it gives consistent (not noisy) vector fields.

Note that for simplicity the video pictures (i.e. their pixels) and motion vector fields valid for the same time instant are drawn on top of each other, so that their geometrical collocation can be shown (in real life one can display this by showing only the grey value of the pixels and replacing their color by a color coding indicative of the calculated motion vector for a particular pixel in an object). Only one dimension (e.g. a horizontal line along an x-axis through the picture) can be shown. To be able to show an object shape, e.g. a car shaped foreground object 101, a kind of perspective is used, making the object flat around its section along the chosen horizontal picture line. The motion vector fields are shown in position along the video pictures by use of ellipses, indicating regions of approximately constant velocity, e.g. a region rBG in the first motion vector field were a zero background motion is found. In order not to complicate the discussion even further, it is assumed that there is only one foreground object moving to consecutive x-positions 101, 105 along a picture frame in time, and a stationary background. The skilled person can easily verify that the proposed method will also work for more complex vector fields, and were extra information is needed for tackling more complex vector fields without introducing considerable errors this will be stated below. However it should be mentioned that in a video compression system errors are not over-important, since errors in both vector fields or predicted images can be corrected by adding corrective residues, be it at the cost of additional bits to be transferred.

A problem with the 3DRS and all other vector fields estimated on the basis of the 2^{nd} and 3^{rd} video pictures is that it is incorrect, and hence cannot simply be used for predicting a following, fourth video picture 127, neither by projecting pixels towards it from the third video picture 125, nor by creating a third motion vector field Mv3 valid for the temporal instant t4 of the fourth video picture 127 and usable for fetching pixels from the third video picture 125.

The problem with such motion estimation “looking for matches in a previous picture” is that in uncovering regions the correct (background) motion vector cannot be estimated. Why this is so is shown schematically in FIG. 2, which shows a subset 200 of the video pictures of FIG. 1, for illustrating the estimation of the first vector field (note that it should be clear to the skilled person that irrespective of the term first, the calculation moments of the first and second vector fields may be swapped). In foreground regions there is no problem, since the foreground object 105 is never occluded, hence always present in the consecutive pictures. The same is true for background objects in a covering region COV. The house object 201 can be found back in the previous picture, hence there is a good match between the vector field regions and the video picture objects in foreground and covering regions. As a first approximation the vectors obtained in the first motion vector field Mv1 by analyzing the motion from the past, e.g. a first motion vector v1, are also valid for the remainder of the motion from this time instant t3 towards the future (the second motion vector v2 being the inverse of v1), the errors in this approximation being described below with the aid of FIG. 5.

It should be noted that for some motion estimators there is substantially a good match up to second order effects. If e.g. vectors are calculated for 8×8 blocks, only one vector is allocated to a block, hence a few pixels of the background object falling within the block mainly comprising foreground object pixels will be allocated the wrong vector.

However in an uncovering region UNCOV2 there will be a problem (erroneous motion vectors in region rERR), since a second house object 203 cannot find its match in the previous video picture, since at that time instant the second house object was still covered by the foreground object 101, hence invisible. It can be shown mathematically that for a 3DRS motion estimator, instead of a correct background motion vector, typically a foreground motion vector is allocated, since a correct background motion vector fetches data from the foreground object, which is usually more dissimilar to the second house object 203 than pixels fetches from an incorrect position in the background, determined by projecting a foreground motion vector to the previous picture. Other motion estimators may produce any kind of erroneous motion vector for uncovering regions.

There are two strategies for solving the problem of incorrect motion vectors which are important for elucidating the present invention.

1) One can correct the erroneous vectors by sending a residue of motion vector updates. This is what is to be avoided as much as possible by the present invention, since it amounts to sending additional data, lowering the compression factor.
2) One can use a more advanced motion estimation strategy, e.g. estimating the motion based on a picture both from the past AND the future. This might be done in an encoder, since all pictures are available. However when sending as little information to the decoder as possible, in particular information of vector fields, the decoder needs to be able to do predictions of the missing information. The encoder emulates what the decoder predicts and can correct unsatisfactory predictions. The decoder does not have the information of the fourth video picture 127 yet, since this is to be predicted and reconstructed, hence a three picture based motion estimation is impossible.

However a three-picture based motion estimation CAN be done for the previous motion vector field, namely the second motion vector field Mv2.

With the aid of FIG. 3, now a preferred embodiment for arriving at a well-matching second motion vector field (with well-matching is meant that substantially all foreground pixels are allocated a foreground motion vector, but more importantly that substantially all background pixels are allocated a background motion vector. The “substantially” is introduced because in practical realizations there may still be small errors due to e.g. block size, however the dominant effect of matching errors due to the covering/uncovering occlusions is not present in a well-matching motion vector field) is described, namely three-picture motion estimation. It should be emphasized however that other methods may be employed, as long as the second motion vector field Mv2 is well matching, since this precise matching to the underlying video objects will be used to correct the erroneous first motion vector field Mv1. E.g. according to the principles of WO01/88852 partially matching vector fields can be obtained from only 2-picture motion estimation on both the temporal position of the second and third video picture. Especially when higher knowledge about the types of object (in particular which is the foreground object) is present, the partially correct second motion vector field Mv2 (i.e. the motion vectors around the uncovering region) can be used to correct the erroneous uncovering region of the first motion vector field Mv1. A good exemplary heuristic for detecting foreground vs. background objects/motion vectors is that foreground objects are usually near the center of a picture frame, whereas pixels near the borders belong to the background.

FIG. 3 describes an exemplary 3-picture motion estimation for obtaining the second motion vector field Mv2. As can be seen the ellipses rBG1′ rFG2 and rBG2′ denoting the regions of allocated background and foreground vectors substantially match with the object positions. This can be realized e.g. with the following strategy:

a) calculate both the backward (from the past) match (with a first e.g. background motion vector prediction candidate v3) and the forward (to the future) match (with a vector of the same predicted magnitude but opposite sign v5)
b) do the same for at least one other candidate motion vector, which should approximately be the foreground motion vector (vectors v13 and v15)
c) check the match errors for at least the two vectors to be tested for motion towards past and future (e.g. according to a classical “sum of absolute differences [SAD]” criterion or more advanced matching criterion according to prior art): there should typically be one well-matching pixel block/region (low SAD) and three higher SADs. The lowest SAD then determines which is the correct motion for that pixel or block of pixels. More advanced strategies can be used to get the correct vector on the basis of the 4 SADs.

Since for this motion estimation there is always a match for a background pixel region (to the future or past) well-matching vector fields can be found.

Other motion estimations can be used also for obtaining a well-matching second motion vector field, e.g. on the basis of two 2-picture motion estimations around picture 123, e.g. the one described in WO2003/067523.

FIG. 4 describes an example of how to correct the first motion vector field Mv1 given a well-matching second motion vector field Mv2. Preferably first a region of uncovering is detected in the well-matching second motion vector field Mv2, e.g. by looking for motion vectors pointing away from each other (diverging objects) as described in WO2000/011863. Then for a well matching vector field the position of the foreground/background border (point A) is found in the correct geometrical position (x,y). In the first motion vector field Mv1 this border should be located at the geometrical position of point A displaced by the foreground motion vector of point A (i.e. at point B). The vector field is likely erroneous up to the position of point A displaced with the background vector estimated in Mv2 adjacent to point A (point C). This means that a vector outside the erroneously estimated region between points A and C, i.e. e.g. at point D will be a correctly estimated background vector.

To predict the correct vectors in the region rFRR, different prediction models can be used, e.g. in case of a uniform background motion, the vector found at point D will be allocated to all points/blocks/segments within rERR. In case of a perspective background motion, its parameters may be estimated on correct background motion regions, and this model is then used to calculate the most likely motion in the region rERR. This corrected first motion vector field Mv1 may be used, giving rise to not too many errors for pixel value prediction, even if no (small !) corrective motion residue is encoded/transmitted for the first motion vector field (the correction then entirely happening by the encoded pixel values residue).

Other corrective strategies than the elaborated one may be employed, e.g. the uncovering region may be estimated more coarsely (e.g. simply a number of pixels larger than the largest likely motion vector difference to either side), and corrections may e.g. be based on global knowledge of motion (e.g. background is stationary). However the above accurate version of the correction [also called retiming of the motion vector field] (of which the accuracy may be even further improved) is preferred for complicated motion scenes (e.g. for a train entering a station a first stationary pillar may be in the background of the train, but an adjacent stationary pillar may be in the foreground).

Up to now the core of the invention was described: calculating a first “incorrect” motion vector field Mv1 as close as possible to an image to be predicted (to avoid problems with e.g. acceleration), calculating a well-matching second motion vector field Mv2, and correcting the first motion vector field Mv1 to have a well-matching first motion vector field Mv1 based on the second motion vector field Mv2, e.g. by means of a retiming. For the further step of prediction of the fourth video picture 127, two different strategies can be used, either a pixel fetching strategy (which is most common in video compression) or a projection (which is less popular in view of some difficulties). It is emphasized that these two methods of video compression have unity of invention, since they both use the novel and inventive single general inventive concept of correcting the closest derivable motion vector field by taking into account knowledge of a previous well-matching motion vector field, embodied in the above special technical features of the core of the present invention.

FIG. 5 illustrates the making of a third vector field Mv3 which can be used later for the fetching of pixels from the third video picture 125 towards the fourth video picture 127 to be predicted. In order to obtain the vector field all vectors of the first vector field Mv1 are projected along their direction to a new position in the third vector field Mv3, e.g.:

v₃(x+v₁^{x}(x,y),y+v₁^{y}(x,y))=v₁(x,y) [Eq. 1],

in which e.g. v₁^{x}(x, y) is the x-component of the vector present at location (x,y) in the first vector field v₁. The assumption underlying this projection is that at least over these two video pictures there is linear (non or mildly accelerating) motion. E.g. the vector present at position E is copied to position F, and shown as v3BG (drawn somewhat smaller to distinguish with the projection to the new position in the third motion vector field/fourth video picture itself). If the projections don't exactly coincide with positions in the third motion vector field Mv3 were there should be an allocated vector (e.g. for each pixel, block, etc.), e.g. because of small errors between the values of neighboring vectors, an interpolation step may be applied, e.g. linear interpolation of the x and y components of neighboring vectors (as is well-known from prior art).

Just as for the estimation of the first vector field Mv1 there are again problems with this projection in the covering and uncovering regions. E.g., in the covering region COV, two vectors project to the same position 111, namely correctly a foreground motion vector vFG and incorrectly a background motion vector vBG. To avoid this situation and make sure that always the correct foreground motion vector is allocated, one can e.g. mark or eliminate certain background motion vectors, so that their projection will not occur, but only the projection of the foreground motion vectors. The region to mark (see the crosses xxx) can gain be found by calculating the position (in the frame of the third video picture) of the border between the foreground and background motion region in the third and fourth video pictures. Alternative algorithms can be designed doing the same thing, e.g. checking when allocating a vector in the third motion vector field Mv3 whether a vector was already allocated, and verifying whether the first allocated is actually a foreground or background motion vector (e.g. by calculating a difference with a template foreground and background motion vector), and in the latter case replacing it with the second projected vector.

Secondly, there will be regions UNCOV were no vectors were projected to Similar strategies could be used as for filling the uncovering regions of the first motion vector field Mv1, e.g. zero order hold copying of a background vector, perspective modeling, etc. However since as shown below, the fetching prediction cannot fetch the right pixels from the previous image even with the correct background motion vectors anyway, there is no need to waste to many computations to improve these motion vectors to obtain the theoretically correct motion vectors, as the errors can still be corrected with video picture pixel residues. One option is to do no allocations of vectors at these positions (i.e. the vectors there typically behave like a zero motion vector to which they were initialized). A more intelligent action is to fill in foreground motion vectors, which will fetch from incorrect positions in the background. This will lead to a lower residue however since different parts of the background are usually more like each other than like the foreground (the background may be approximately uniform e.g.).

Fetching with a given motion vector field is known to the skilled person, so should not be explained with an additional drawing. Each vector of the predicted (and if required corrected with a further small correction motion vector field) third motion vector field Mv3 points to a pixel or group of pixels in the third video picture 125, which (group of) pixels is copied to a position in the fourth video picture 127 corresponding to the position in the third motion vector field Mv3 of the used motion vectors. There are two problems with the so-predicted video picture:

a) most of the pixel regions look very like an original picture of the compressed video sequence, however there are small errors due to such factors as changes in lighting, incorrectly or inaccurately predicted motion, etc.
b) in uncovering regions background motion vectors incorrectly fetch data from incorrect positions in a previous picture.

Both situations are handled by adding a corrective picture (so-called residue), which contains the remainder R=T−P (in which T is the true video picture and P the above described prediction), which typically requires less bits for its description.

Instead of projecting to motion vector field to the new temporal instant t4 of the picture 127 to be predicted and fetching pixels from the past, the corrected first motion vector field Mv1 can also be used to project pixels from the third video picture 125 to the fourth video picture 127. In this case the knowledge of what is foreground and background is similarly used:

a) in the case of double pixel projection only the foreground pixel (i.e. a pixel which has a foreground motion vector) is projected, and
b) where there is no pixel projecting, the residue is encoded, typically after a first prediction/interpolation of likely pixel values in the uncovering region based on the values of background pixels just outside the uncovering regions (e.g. simply copying the first background pixel outside the uncovering region, or more complex texture prediction models for predicting a likely pattern of pixels inside the uncovering region. An example is to use Markov Random Field hole filling).

So in regions where no pixel projection occurred, no further action is required, since they can be fully reconstructed from the compressed/transmitted residue, but to save bits it is best if some (fixed or variable and e.g. indicated as one among a number of available prediction methods by an indicator in the compressed stream metadata) prediction is used by the decompressor, since this amounts to smaller residues.

FIG. 6 schematically shows an apparatus 600 (typically a dedicated ASIC, or programmed general purpose processor, or another currently employed system for video compression) having both compression and decompression functionality. The skilled person will now how to put the features of the above described method in a separate video compressor and video decompressor.

The apparatus has an input for inputting a video signal Vin, which is typically stored in a memory 601. The input video signal is typically taken from a network 637, by which is meant anything ranging over airways television transmission, internet, in-home data network, portable outdoors communication, etc.

First the compression functionality is described, in which case Vin is an uncompressed signal (which if analog is first digitized-not shown). A first motion estimation unit 605 is arranged to extract two sequential pictures from the memory and perform the 2-picture motion estimation described above. This could be done with original pictures, but to mirror what the decompressor can do (and only transmit residue data for features which it cannot predict on the basis of already decoded pictures) predicted pictures according to the present invention should preferably be used, and even more preferably compressed/decompressed pictures, according to the full compression scheme (i.e. going through DCT transformation, quantization, etc.). The resulting “erroneous” first motion vector field is written in second memory 603 for motion vectors and motion vector fields. Similarly a second motion estimation unit 607 performs the three-picture motion estimation. Optionally a third motion estimation unit 606 may be comprised, arranged to perform a high quality motion estimation taking into account all kinds of data present at the compression side (future video pictures, annotations by a human operator such as data on inserted video graphics objects, . . . ), and arranged to save to memory 603 an update motion vector field for the first (and when a fetch strategy is used the third) motion vector field. A correction unit 609 corrects the first motion vector field Mv1 with the second motion vector field Mv2 according to the above described method. In an exemplary embodiment the correction unit 609 comprises a covering/uncovering detector 614, arranged to detect covering and uncovering regions in the second and/or the first motion vector field (e.g. described above on the basis of the values of vectors or on the basis of the video pictures themselves, such as SADs derived from the video picture object matching). A retimer 613 arranged to project borders of regions of different motion to different time instants, and a corrector 611 arranged to re-allocate motion vectors are also typically comprised in the correction unit 609. Furthermore a motion vector field prediction unit 615 is comprised. It comprises a foreground/background detector 621, for detecting which of the motion vectors are foreground and which are background motion vectors (at least in a region of covering). Various vector-based or pixel-based foreground/background strategies may be employed (see e.g. WO01/89225). The motion vector field prediction unit 615 further comprises a projection unit 619 or projecting vectors to a different time instant as described with FIG. 5. It also comprises an interpolation unit 617 for allocating vectors in regions where no projection occurred. Output from the motion vector field prediction unit 615 is the third motion vector field Mv3.

A picture prediction unit 625 takes as input original pictures, previously predicted pictures (in particular the predicted third video picture 125), the first motion vector field Mv1 for projection prediction, and for a fetching prediction the third motion vector field Mv3. It then applies a prediction of the fourth video picture 127 to be reconstructed according to one of the two above described strategies (projection or fetch). A comprised difference calculation unit 623, calculates the residual picture as the difference between the prediction of the picture according to the invention and the original, and stores the residual in the picture memory 601.

Finally to arrive at a compressed video stream, a (standard-compliant) compression unit 650 performs operations known from prior art compressors—such as MPEG2, AVC, etc.—, e.g. DCT transformation, stream formatting, etc. The compressed output signal Vout′ (motion vector and pixel data) may be stored on a data storage device 643, transmitted over a network 637, etc.

Now the decompression functionality is described (most of it was already described, since the compressor mirrors what the decompressor can predict). The input signal Vin is now compressed and typically consists of intraframes I (which are pictures compressed in their entirety, i.e. reconstructable without data from other pictures) and updating data for motion-predicted pictures P. Furthermore, vector field data is transmitted for doing the video picture predictions. The transmitted data for the present method of compression/decompression will be different from the transmitted data for a standard (e.g. MPEG2, or AVC) compression, in particular their will be less motion vector data, since most of the motion vector field data is predicted in the decompressor according to the present invention, hence less update data is required. A scheme could be designed which is reasonable compatible which standard decompressors though, by making the input signal scalable. A first layer 635 comprises the pixel data and only a little bit of motion vector data 633, whereas a second layer contains the “full” motion vector data for a standard compressor. This second layer need not be received by a decompressor according to the present invention. The quality of the decompressed pictures with a standard decompressor will be slightly lower.

The memory 601 comprises data of both residue pictures and already fully decompressed pictures. The first motion estimation unit 605 is arranged to extract two already decompressed pictures from the memory and perform the 2-picture motion estimation described above, and the same applies to the three-picture motion estimation. The correction unit 609, motion vector field prediction unit 615, and picture prediction unit 625 perform exactly the same function as described above, but now on actually received compressed video data and video pictures and motion vector fields predicted therefrom, instead of predictions of what the decompressor would do in the compressor. The output of the video prediction unit 625 are pictures that look very similar to those of the original sequence, and they are stored in memory 601. Note that mutatis mutandis unit 650 a decompression unit 651 is required at the input to do the unpacking, inverse DCT etc., so that what is actually written in the picture memory 601 are digital pictures, i.e. pixel images. Finally a decompressed sequence of video pictures may be conditioned into an output signal Vout by a conditioning unit 652 (which may e.g. perform digital/analog conversion, encoding as a television standard such as PAL, etc.), and this output signal may be transmitted e.g. to a display 641.

As is typical for compression, the decompressor does essentially the same thing as the compressor which emulates this behavior, only the compressor determines a residue by subtracting the obtained prediction from the original picture, whereas the decompressor adds the received decompressed residue to the prediction. Note that prediction may also involve multiple previous pictures: e.g. a vector may be doubled for fetching a pixel from a pre-previous picture and this may be averaged with the pixel fetched from the previous picture.

Note that the further specific algorithmic embodiments of the three-picture based estimation of claim 2 or 4, the retiming of claim 3, the foreground vector determination strategy of claim 5, and the background vector determination strategy of claim 6, can be substituted in any combination in the steps of claim 1, or where present in alternative claim 7 (mut. mut. the decompression methods), and that the corresponding means of the basic (de)compression apparatuses (typically an IC or software enabled processor) can be further arranged to perform corresponding functions. The apparatuses (digital television unit, video signal recorder, portable video apparatus) comprising the basic (de)compressor, can comprise either a single or multiple compressor(s) or decompressor(s) or the both, dependent on the actual realization (e.g. portable device only capable of receiving and displaying compressed video only needs a decompressor, but if storage is included, a compressor may also be required, e.g. for compressing (after digitizing) an analog signal).

The algorithmic components disclosed in this text may in practice be (entirely or in part) realized as hardware (e.g. parts of an application specific IC) or as software running on a special digital signal processor, or a generic processor, etc.

Under computer program product should be understood any physical realization of a collection of commands enabling a processor—generic or special purpose—, after a series of loading steps (which may include intermediate conversion steps, like translation to an intermediate language, and a final processor language) to get the commands into the processor, to execute any of the characteristic functions of an invention. In particular, the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

Some of the steps required for the working of the method may be already present in the functionality of the processor instead of described in the computer program product, such as data input and output steps.

It should be noted that the above-mentioned embodiments illustrate rather than limit the invention. Apart from combinations of elements of the invention as combined in the claims, other combinations of the elements are possible. Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

1. A method of video signal compression comprising:
a) calculating a first motion vector field (Mv1) at a temporal location (t3) of a third video picture (125) by using pixel data of a second video picture (123) and the third video picture;
b) calculating a second motion vector field (Mv2) at a temporal location (t2) of the second video picture (123), in which second motion vector field (Mv2) a foreground motion region (rFG2) composed of positions of foreground motion vectors, having a magnitude substantially equal to the motion of a foreground object (101), substantially collocates spatially with positions of pixels of the foreground object (101) and not with pixels of a background object (103, 103′);
c) correcting erroneous foreground motion vectors (rERR) in an uncovering region of the first motion vector field (Mv1) on the basis of the second motion vector field (Mv2);
d) determining in a region (COV) of the first motion vector field corresponding to covering of background object pixels by the foreground object which of two vectors, projecting to a same spatial position in a future picture, is a foreground motion vector (vFG) and which is a background motion vector (vBG);
e) projecting motion vectors of the first motion vector field to a temporal location (t4) of a fourth video picture (127) to be predicted, obtaining a third motion vector field (Mv3), comprising allocating a foreground motion vector (vFG) in the case of two vectors projecting to the same spatial position in the third motion vector field (Mv3); and
f) predicting the fourth video picture (127) by using the third motion vector field (Mv3) for determining positions of pixels to be fetched from at least one previous image (125).

2. A method of video signal compression as claimed in claim 1, in which the calculating of the second motion vector field (Mv2) is done on the basis of the third video picture (125), the second video picture (123) and a first video picture (121).

3. A method of video signal compression as claimed in claim 1 or 2, in which the correcting of the erroneous foreground motion vectors in the first motion vector field (Mv1) comprises:
detecting an uncovering region in the second motion vector field (Mv2);
deriving on the basis of this uncovering region a region (rERR) of erroneous motion vectors in the first motion vector field (Mv1); and
allocating background motion vectors to the pixels of the region (rERR) of erroneous motion vectors.

4. A method of video signal compression as claimed in claim 2, in which the calculating of the second motion vector field (Mv2) is done with a three-picture motion estimation.

5. A method of video signal compression as claimed in claim 1 in which the foreground motion vector (vFG) which is allocated, in the case of two vectors projecting to the same spatial position in the third motion vector field (Mv3), is the foreground one of the two projecting vectors.

6. A method of video signal compression as claimed in claim 1 in which a vector allocated in spatial positions where no projecting of a vector from the first vector field occurred, is a vector giving compared to a background vector a good prediction of the pixels of the fourth picture.

7. A method of video signal compression comprising:
a) calculating a first motion vector field (Mv1) at a temporal location (t3) of a third video picture (125) by using pixel data of a second video picture (123) and the third video picture;
b) calculating a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) correcting erroneous foreground motion vectors in an uncovering region of the first motion vector field (Mv1) on the basis of the second motion vector field (Mv2);
d) determining in a region (COV) of the first motion vector field corresponding to covering of background object pixels by the foreground object which of two vectors, projecting to a same spatial position in a future picture, is a foreground motion vector (vFG) and which is a background motion vector (vBG);
e) projecting with the motion vectors of the corrected first motion vector field (Mv1) pixels of the third video picture (125) to a fourth video picture (127) initialized to zero, comprising in the case of double projection, projecting only pixels having a foreground motion vector (vFG).

8. A method of video signal decompression comprising:
a) calculating a first motion vector field (Mv1) at a temporal location (t3) of a previously decompressed third video picture (125) by using pixel data of a previously decompressed second video picture (123) and the third video picture;
b) calculating a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) correcting erroneous foreground motion vectors in an uncovering region of the first motion vector field (Mv1) on the basis of the second motion vector field (Mv2);
d) determining in a region (COV) of the first motion vector field corresponding to covering of background object pixels by the foreground object which of two vectors, projecting to a same spatial position in a future picture, is a foreground motion vector (vFG) and which is a background motion vector (vBG);
e) projecting motion vectors of the first motion vector field to a temporal location (t4) of a fourth video picture (127) to be predicted, obtaining a third motion vector field (Mv3), comprising allocating a foreground motion vector (vFG) in the case of two vectors projecting to the same spatial position in the third motion vector field (Mv3); and
f) predicting the fourth video picture (127) by using the third motion vector field (Mv3) for determining positions of pixels to be fetched from at least one previous image (125).

9. A method of video signal decompression comprising:
a) calculating a first motion vector field (Mv1) at a temporal location (t3) of a previously decompressed third video picture (125) by using pixel data of a previously decompressed second video picture (123) and the third video picture;
b) calculating a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) correcting erroneous foreground motion vectors in an uncovering region of the first motion vector field (Mv1) on the basis of the second motion vector field (Mv2);
d) determining in a region (COV) of the first motion vector field corresponding to covering of background object pixels by the foreground object which of two vectors, projecting to a same spatial position in a future picture, is a foreground motion vector (vFG) and which is a background motion vector (vBG);
e) projecting with the motion vectors of the corrected first motion vector field (Mv1) pixels of the third video picture (125) to a fourth video picture (127) initialized to zero, comprising in the case of double projection projecting only pixels having a foreground motion vector (vFG).

10. A video compression apparatus (600) comprising:
a) a first motion estimation unit (605) arranged to calculate a first motion vector field (Mv1) at a temporal location (t3) of a third video picture (125) by using pixel data of a second video picture (123) and the third video picture;
b) a second motion estimation unit (607) arranged to calculate a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) a correction unit (609) arranged to correct erroneous foreground motion vectors in the first motion vector field (Mv1) on the basis of the second motion vector field (Mv2);
d) a foreground/background detector (621) arranged to determine in a region (COV) of the first motion vector field corresponding to covering of background object pixels by the foreground object which of two vectors, projecting to a same spatial position in a future picture, is a foreground motion vector (vFG) and which is a background motion vector (vBG);
e) a projection unit (619) arranged to project motion vectors of the first motion vector field to a temporal location (t4) of a fourth video picture (127) to be predicted, yielding as output a third motion vector field (Mv3), comprising allocating a foreground motion vector (vFG) in the case of two vectors projecting to the same spatial position in the third motion vector field (Mv3);
f) an interpolation unit (617) arranged to allocate a motion vector in spatial positions (UNCOV) of the third motion vector field (Mv3) where no projecting of a vector from the first vector field occurred which yields a good prediction of the true pixel in that position; and
g) a picture prediction unit (625) arranged to predict the fourth video picture (127) by using the third motion vector field (Mv3) for determining positions of pixels to be fetched from at least one previous image (125).

11. A video compression apparatus (600) comprising:
a) a first motion estimation unit (605) arranged to calculate a first motion vector field (Mv1) at a temporal location (t3) of a third video picture (125) by using pixel data of a second video picture (123) and the third video picture;
b) a second motion estimation unit (607) arranged to calculate a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) a correction unit (609) arranged to correct erroneous foreground motion vectors in the first motion vector field (Mv1) on the basis of the second motion vector field (Mv2);
d) a foreground/background detector (621) arranged to determine in a region (COV) of the first motion vector field corresponding to covering of background object pixels by the foreground object which of two vectors, projecting to a same spatial position in a future picture, is a foreground motion vector (vFG) and which is a background motion vector (vBG);
e) a picture prediction unit (625) arranged to project with the motion vectors of the corrected first motion vector field (Mv1) pixels of the third video picture (125) to a fourth video picture (127) initialized to zero, and arranged to in the case of double projection project only pixels having a foreground motion vector (vFG).

12. A video decompression apparatus (600) comprising:
a) a first motion estimation unit (605) arranged to calculate a first motion vector field (Mv1) at a temporal location (t3) of a previously decompressed third video picture (125) by using pixel data of a previously decompressed second video picture (123) and the third video picture;
b) a second motion estimation unit (607) arranged to calculate a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) a correction unit (609) arranged to correct erroneous foreground motion vectors in the first motion vector field (Mv1) on the basis of the second motion vector field (Mv2);
d) a foreground/background detector (621) arranged to determine in a region (COV) of the first motion vector field corresponding to covering of background object pixels by the foreground object which of two vectors, projecting to a same spatial position in a future picture, is a foreground motion vector (vFG) and which is a background motion vector (vBG);
e) a projection unit (619) arranged to project motion vectors of the first motion vector field to a temporal location (t4) of a fourth video picture (127) to be predicted, yielding as output a third motion vector field (Mv3), comprising allocating a foreground motion vector (vFG) in the case of two vectors projecting to the same spatial position in the third motion vector field (Mv3);
f) an interpolation unit (617) arranged to allocate a motion vector in spatial positions (UNCOV) of the third motion vector field (Mv3) where no projecting of a vector from the first vector field occurred which yields a good prediction of the true pixel in that position; and
g) a picture prediction unit (625) arranged to predict the fourth video picture (127) by using the third motion vector field (Mv3) for determining positions of pixels to be fetched from at least one previous image (125).

13. A video decompression apparatus (600) comprising:
a) a first motion estimation unit (605) arranged to calculate a first motion vector field (Mv1) at a temporal location (t3) of a previously decompressed third video picture (125) by using pixel data of a previously decompressed second video picture (123) and the third video picture;
b) a second motion estimation unit (607) arranged to calculate a second motion vector field (Mv2) at a temporal location (t2) of the second video picture (123), in which second motion vector field a foreground motion region (rFG2) composed of positions of foreground motion vectors, substantially equal to the motion of a foreground object (101), substantially collocates spatially with positions of pixels of the foreground object (101) and not with pixels of a background object (103, 103′);
c) a correction unit (609) arranged to correct erroneous foreground motion vectors in the first motion vector field (Mv1) on the basis of the second motion vector field (Mv2);
d) a foreground/background detector (621) arranged to determine in a region (COV) of the first motion vector field corresponding to covering of background object pixels by the foreground object which of two vectors, projecting to a same spatial position in a future picture, is a foreground motion vector (vFG) and which is a background motion vector (vBG);
e) a picture prediction unit (625) arranged to project with the motion vectors of the corrected first motion vector field (Mv1) pixels of the third video picture (125) to a fourth video picture (127) initialized to zero, and arranged to in the case of double projection project only pixels having a foreground motion vector (vFG).

14. A compressed video signal produced by a method as claimed in claim 1 or claim 7, comprising only residue motion vectors for temporal positions of motion predicted pictures, which residue is in view of its spatial structure clearly identifiable as only usable for correcting temporally predicted motion vector fields.

15. A computer program product comprising a respective processor readable means corresponding to each of the steps a-f of claim 1, enabling a processor to execute the method according to claim 1.

16. A computer program product comprising a respective processor readable means corresponding to each of the steps a-e of claim 7, enabling a processor to execute the method according to claim 7.

17. A computer program product comprising a respective processor readable means corresponding to each of the steps a-f of claim 8, enabling a processor to execute the method according to claim 8.

18. A computer program product comprising a respective processor readable means corresponding to each of the steps a-e of claim 9, enabling a processor to execute the method according to claim 9.

19. A digital television unit comprising a video decompression apparatus (600) as claimed in claim 12 or 13.

20. A video signal recorder comprising a video compression apparatus (600) as claimed in claim 10 or 11.

21. A portable video apparatus comprising a video decompression apparatus (600) as claimed in claim 12 or 13 and/or a video compression apparatus (600) as claimed in claim 10 or 11.
